(19) United States
(12) Patent Application Publication
(10) Pub. No.: US 2008/0179099 A1
(43) Pub. Date: Jul. 31, 2008

(54) Portable golf hole cutting device

(75) Inventor: Edward McNulty, Midland, VA (US)

Correspondence Address: DIEDERIKS & WHITELAW, PLC, #301, 12471 Dillingham Square, Woodbridge, VA, 22192, US

(73) Assignee: JEG, INC.

(21) Appl. No.: 11/699,328

(22) Filed: Jan. 30, 2007

(51) Int. Cl. E21B 19/08; A01B 45/04

(52) U.S. Cl. 175/162; 172/22

(57) ABSTRACT

A golf hole cutting device includes an impact portion and a cutting portion. The impact portion preferably takes the form of a portable impact hammer, while the cutting portion includes a cutting head and a shaft having a terminal portion that connects with the portable impact portion. The cutting head includes a cylindrical, hollow main body portion having a first end portion which is adapted to penetrate soil and leads to a second end portion. With this construction, the impact portion is employed to deliver a series of rapid linear impacts to the terminal portion of the shaft to drive the cutting head down into soil of a putting green to form a golf hole.

### BACKGROUND OF THE INVENTION

1. Field of the Invention

The present invention pertains to the art of golf and, more particularly, to a readily portable device for rapidly and effectively cutting a golf hole in a putting green.

2. Discussion of the Prior Art

Devices for making holes in golf course putting greens are well known in the art. A typical hole cutting device includes a cutting head attached to a T-shaped handle by a shaft. One such device is shown in FIG. 1 as a lever extraction hole cutter 2. Hole cutter 2 includes a cutting head 3, a T-shaped handle 4 and a pivoting lever assembly 6 which is attached to a shaft 7 that interconnects cutting head 3 and handle 4. Lever assembly 6 is operatively connected to a push plate 8 provided in cutting head 3. In use, an operator places cutting head 3 in a desired location, then pushes down on and rotates handle 4 back and forth to form a hole. As the hole is formed, cutting head 3 gets filled with the grass and soil being removed, thereby establishing a soil plug within cutting head 3. Hole cutter 2 can then be moved to a prior formed hole location whereupon lever assembly 6 is operated to eject the soil plug from cutting head 4 so that the soil plug fills the prior formed hole.

While the above-described device functions and has been in use for quite some time, there exist several drawbacks with hand operated cutting devices. More specifically, hand operated hole cutting devices are awkward to operate. After positioning the cutting head, an operator must not only oscillate the handle, but also exert a sufficient downward force. This combined motion often leads to an off-axis or non-vertical hole having a raised edge which forms a lip. Such a hole would be unacceptable for golf play and thus would require additional effort to repair. In order to prevent off-axis holes, the operator must proceed slowly and with a great deal of care when manually forming a hole in this manner.

In addition, it is often times difficult for an operator to force a hole cutting device downward through hard material, such as packed clay or shale. When an operator encounters clay and/or shale, additional force is required in forming the hole. Often times, the additional force results in an off-axis hole that, again, must be properly repaired in order to be suitable for golf. If it is impossible to penetrate the hard material, the hole site must be abandoned for another potential hole site. Thus, in general, manual hole cutting devices of the prior art are slow, require careful operation and often times require additional labor from a groundskeeper to make a hole acceptable for golf play.

Based on the above, there still exists a need for a golf hole cutting device that can be used to rapidly and efficiently produces a hole, even through hard material, with minimal chances of being off-axis or creating raised edges.

### SUMMARY OF THE INVENTION

The present invention is directed to a golf hole cutting device including an impact portion and a cutting portion. The impact portion preferably takes the form of a portable impact hammer, while the cutting portion includes a cutting head and a shaft having a terminal portion that connects with the portable impact portion. The cutting head includes a cylindrical, hollow main body portion having a first end portion which is adapted to penetrate soil and leads to a second end portion. The cylindrical, hollow main body portion has a diametric dimension and an even greater height so as to be sized to form standard golf holes in a golf green.

In operation, when the cylindrical, hollow main body portion is placed against the soil of a golf green, rapid and repeated linear impact forces delivered by the impact hammer are directed through the terminal portion of the shaft to the cutting head. The rapid and repeated forces drive the first end portion of the cutting head to substantially vertically penetrate the soil. As the cutting head penetrates the soil, some of the soil fills the hollow main body portion, establishing a soil plug and forming a hole. After the hole is formed, the cutting device is typically moved to a prior hole location where the soil plug is ejected from the hollow main body portion into another, prior hole to serve as fill. With this arrangement, an operator need only maintain vertical alignment, which can be aided by a leveling device, and provide a minimal downward force to form a golf hole.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of a lever extraction hole cutter constructed in accordance with known prior art;

FIG. 2 is a perspective view of a hole cutting device constructed in accordance with the present invention;

FIG. 3 is a detail view of an end portion of the hole cutting device of FIG. 2; and

FIG. 4 is a top view of a leveling device provided as part of the hole cutting device of FIG. 2.

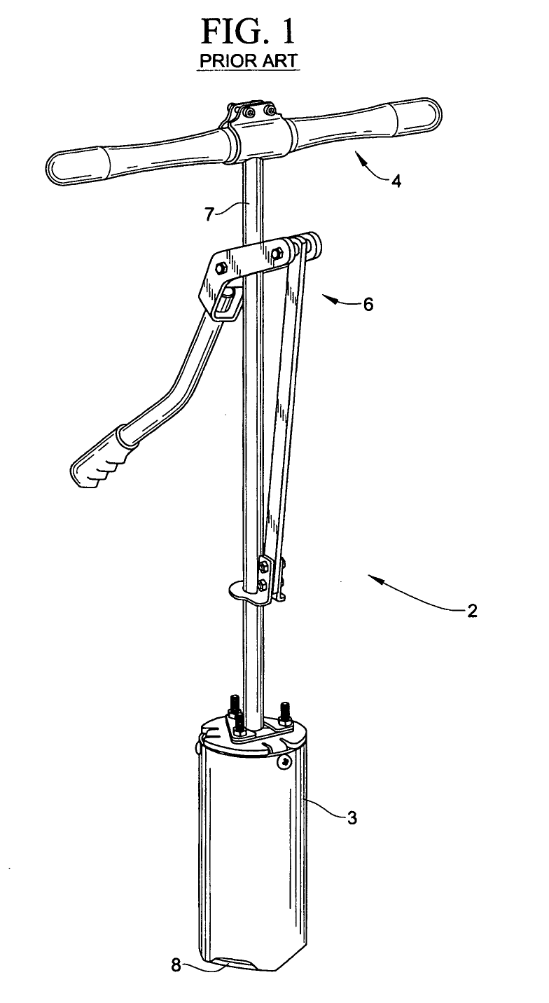

### DETAILED DESCRIPTION OF THE PREFERRED EMBODIMENT

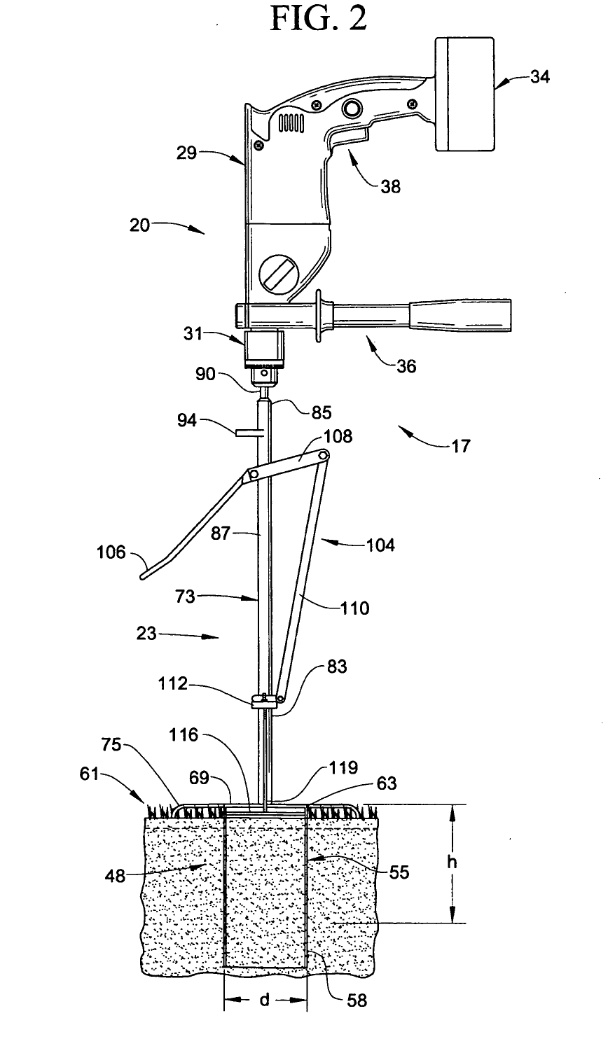

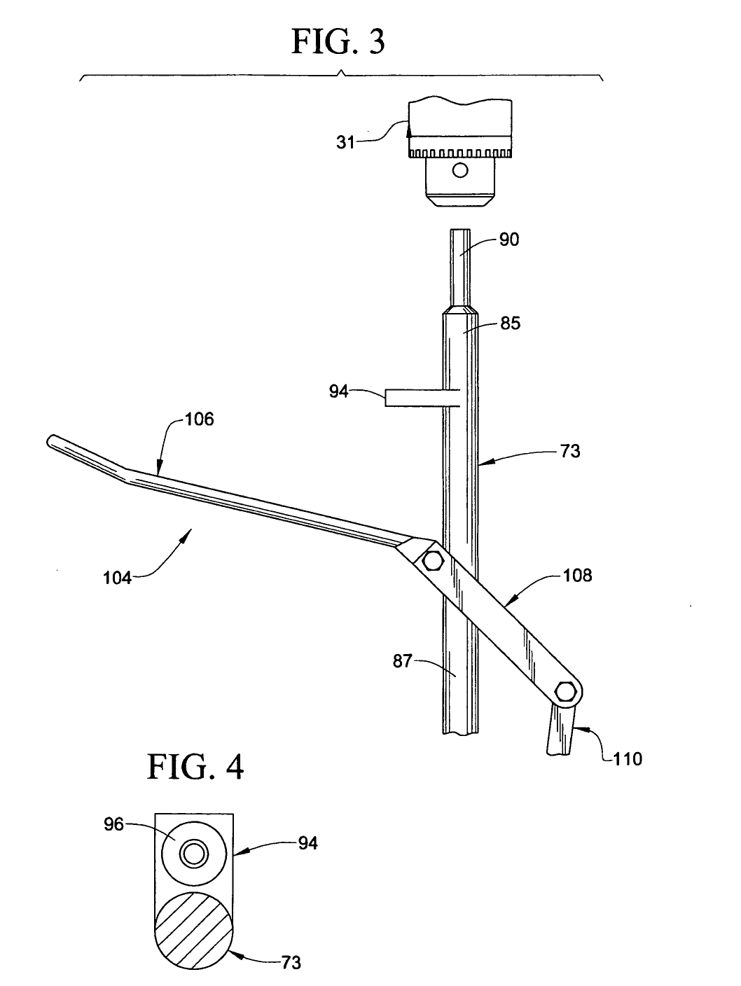

With initial reference to FIGS. 2 and 3, a golf hole cutting device constructed in accordance with the present invention is generally indicated at 17. Golf hole cutting device 17 includes an impact portion 20 and a cutting portion 23. Impact portion 20 takes the form of a portable impact hammer 29 having a drive member 31 that receives and retains generally cylindrical shafts. At this point, it should be understood that drive member 31 can take various forms, such as an adjustable chuck as shown in FIGS. 2 and 3, square drives, splined receivers and the like. In order to enable golf hole cutting device 17 to be readily portable, impact hammer 29 is provided with a battery 34 that can be replaced and/or recharged in a manner known in the art. Impact hammer 29 is shown to include an optional handle 36 that enables a user to easily hold and support golf hole cutting device 17. Impact hammer 29 is also provided with a trigger 38 that, when activated, initiates a series of rapid linear impact forces directed through drive member 31 as will be discussed more fully below.

In accordance with the embodiment shown, cutting portion 23 is provided with a cutting head 48 having a generally cylindrical hollow main body portion 55 including a first end portion 58 that is designed to penetrate soil such as indicated generally at 61. First end portion 58 of main body portion 55 extends to a second end portion 63 which is attached to a flange 69 secured to a shaft 73. Flange 69 can take a variety of different configurations that provide a proper interface between shaft 73 and cutting head 48. Cutting head 48 further includes a boot 75 that establishes a preferred depth for the hole formed by cutting device 17. Preferably, main body portion 55 includes a diametric dimension (d) and a height (h) which is greater than diametric dimension (d), wherein main body portion 55 is sized to cut standard golf holes into greens of a golf course. As will be discussed more fully below, main body portion 55 can take on a variety of shapes, including being multi-faceted, as the present invention does not require a user to rotate cutting head 48 about a vertical axis in order to penetrate soil 61.

In accordance with the invention, shaft 73 includes a first end section 83 which is fixedly attached to flange 69 and leads to a second end section 85 through an intermediate section 87. Preferably, second end section 85 includes a terminal portion 90 which, in the embodiment shown, is tapered so as to be readily received by drive member 31. Of course, the need for a taper depends upon the particular size and configuration of drive member 31. More specifically, terminal portion 90 can take on a variety of forms so long as engagement with drive member 31 can be achieved. In any case, shaft 73 is also shown to be provided with a leveling device 94 which, as best shown in FIG. 4, takes the form of a bubble level 96.

Finally, cutting portion 23 is shown to include a lever assembly 104 which is employed to discharge soil plugs that fill cylindrical, hollow main body portion 55 when holes are formed. In the embodiment shown, lever assembly 104 includes a lever member 106 that extends to a pivoting link member 108 which, in turn, is pivotally connected to a driven member 110. Driven member 110 extends along intermediate portion 87 of shaft 73 to a collet 112 positioned adjacent first end section 83. Collet 112 is connected to a pusher plate 116 by a plurality of push rods, one of which is indicated at 119. Pusher plate 116 is located within cutting head 48 and, as will be discussed more fully below, is selectively shiftable within main body portion 55 as a hole is formed.

In operation, first end portion 58 of main body portion 55 is initially positioned upon an area of a putting green in which a golf hole is desired. At this point, pusher plate 116 is located adjacent first end portion 58, with lever 106 being in a generally raised position. When cutting head 48 is properly positioned as evidenced by leveling device 94, an operator activates trigger 38 which causes impact hammer 29 to deliver a series of linear impact forces to cutting head 48 through shaft 73. The impact forces drive cutting head 48 to substantially vertically penetrate soil 61. As cutting head 48 penetrates soil 61, a portion of soil 61 enters into main body portion 55, forcing pusher plate 116 upward with main body portion 55. As pusher plate 116 moves upward, lever 106 transitions downward. Once the hole has reached a suitable depth as signaled by flange 69 reaching the putting green, trigger 38 is released and cutting device 17 is lifted such that cutting head 48 is withdrawn from soil 61 with the portion of soil 61 retained within main body portion 55. At this point, a plastic cup (not shown) is inserted into the hole and cutting device 17 can be moved to a prior hole, wherein cutting head 48 is lowered into the prior hole and lever 106 lifted to force pusher plate 116 downward, thereby ejecting the portion of soil 61 obtained at the new hole location to fill the prior hole for a particular green.

At this point, it should be readily understood that the present invention provides for a portable and easily operated golf hole cutting device which requires minimal operator imparted forces and, through the application of a series of substantially linear impact forces to the cutting head, readily penetrates hard earth, clay and even shale. The present invention enables a golf course maintenance person to form and refill golf holes in less than one third the time required by an operator employing, for example, a lever extractor 2 constructed in accordance with the prior art.

Although described with reference to a preferred embodiment of the invention, it should be readily understood that various changes and/or modifications can be made to the invention without departing from the spirit thereof. For instance, while shown as employing a hand-held impact hammer, the present invention can be readily mounted to a towed or driven cart and provided with any number of devices that deliver linear impact forces. In addition, the present invention can be fitted with a variety of cutting heads, including those employed for putting greens having a foundation of sand, soil, clay or the like. In general, the invention is only intended to be limited by the scope of the following claims.

1. A golf hole cutting device comprising:
a portable impact hammer having a rechargeable battery and a drive member adapted to accept generally cylindrical shafts, said impact hammer being selectively operable to deliver a series of rapid impact forces;
a cutting head including a cylindrical, hollow main body portion having a first end portion adapted to penetrate soil and a second end portion, said cylindrical, hollow main body portion having a diametric dimension and a height which is greater than the diametric dimension; and
a shaft extending from the cutting head, said shaft including a first end section which is fixedly attached to the cylindrical, hollow main body portion and leads to a second end section through an intermediate section, said second end section having a terminal portion that connects with the drive member wherein, when the cylindrical, hollow main body portion is placed against soil of a golf green, rapid and repeated linear impact forces delivered by operation of the impact hammer powered by the rechargeable battery are directed through the terminal portion to force the first end portion of the cutting head to substantially, vertically penetrate the soil, causing some of the soil to fill the hollow main body portion and be removed upon lifting of the golf hole cutting device, in order to form a golf hole.

2-3. (canceled)

4. The golf hole cutting device according to claim 1, wherein the drive member is constituted by an adjustable chuck.

5. The golf hole cutting device according to claim 4, wherein the terminal portion is provided with a taper, said taper being received by the adjustable chuck.

6. The golf hole cutting device according to claim 1, further comprising: a leveling device adapted to aid an operator with establishing and maintaining a vertical positioning of the cutting head.

7. The golf hole cutting device according to claim 6, wherein the leveling device is mounted to the shaft.

8. The golf hole cutting device according to claim 6, wherein the leveling device is constituted by a bubble level,

9. The golf hole cutting device according to claim 1, further comprising: a lever assembly pivotally mounted to the shaft, said lever assembly being operatively connected to a pusher plate positioned within the hollow main body portion of the cutting head.

10. The golf hole cutting device according to claim 1, further comprising a flange provided at the second end portion of the cutting head.

11. A golf hole cutting device comprising:
a cutting head including a cylindrical, hollow main body portion having a first end portion adapted to penetrate soil and a second end portion, said cylindrical, hollow main body portion having a diametric dimension and a height which is greater than the diametric dimension;
a shaft extending from the cutting head, said shaft including a first end section which is fixedly attached to the cylindrical, hollow main body portion and leads to a second end section through an intermediate section, said second end section having a terminal portion; and
a portable, battery powered means for delivering a series of rapid and repeated linear impact forces to the terminal end of the shaft wherein, when the cylindrical, hollow main body portion is placed against soil of a golf green, the rapid and repeated linear impact forces drive the first end portion of the cutting head to substantially, vertically penetrate the soil, causing some of the soil to fill the hollow main body portion in order to form a golf hole.

12. The golf hole cutting device according to claim 11, further comprising: a leveling device adapted to aid an operator with establishing and maintaining a vertical positioning of the cutting head.

13. The golf hole cutting device according to claim 12, wherein the leveling device is mounted to the shaft.

14. The golf hole cutting device according to claim 12, wherein the leveling device is constituted by a bubble level.

15. The golf hole cutting device according to claim 11, wherein the delivering means is constituted by a portable impact hammer.

16. The golf hole cutting device according to claim 15, wherein the portable impact hammer includes a rechargeable battery.

17. The golf hole cutting device according to claim 14, wherein the impact hammer includes a drive member and the terminal portion of the shaft is provided with a taper, said taper being readily received by the drive member.

18. A method of changing a golf hole on a golf green from a prior hole at a first location to a new golf hole at a second location comprising:
positioning a first end portion of a hollow main body portion of a cutting head upon an area of soil at the second location;
operating a portable, rechargeable battery powered impact hammer attached to a shaft extending from the cutting head to rapidly and repeatedly deliver a series of substantially linear impact forces to the cutting head through the shaft in order to force the cutting head to substantially, vertically penetrate the soil, causing a portion of the soil at the second location to at least partially fill the hollow main body portion;
lifting the hollow main body portion, thereby causing the portion of the soil to be removed from the second location in order to establish the new golf hole at the second location; and
depositing the portion of the soil removed from the second location to the prior hole at the first location.

19. The method according to claim 18, further comprising: properly positioning and maintaining the cutting head relative to the area of soil with a leveling device.

20. The method according to claim 18, further comprising: operating a lever to force the portion of soil out from the hollow main body portion into the prior hole at the first location.
